(19) United States
(12) Patent Application Publication
(10) Pub. No.: US 2013/0221137 A1
(43) Pub. Date: Aug. 29, 2013

(54) PRESSURE REGULATING VALVE

(71) Applicant: Helmar Gruhl, Steinheim An Der Murr (DE)

(72) Inventor: Helmar Gruhl, Steinheim An Der Murr (DE)

(73) Assignee: ROBERT BOSCH GMBH, Stuttgart (DE)

(21) Appl. No.: 13/882,459

(22) PCT Filed: Sep. 20, 2011
(86) PCT No.: PCT/EP2011/066306

§ 371 Date: Apr. 29, 2013

(30) Foreign Application Priority Data
Oct. 29, 2010 (DE) 10 2010 043 092.7

(51) Int. Cl. F02M 61/18

(52) U.S. Cl. CPC F02M 61/18
USPC 239/584

(57) ABSTRACT

The invention relates to a pressure regulating valve for opening and closing a drain of a high-pressure accumulator (12) for an injection device for an internal combustion machine. The pressure regulating valve comprises a valve element (18) having a closing element (29) and a magnetic actuator (17) having an armature (32), wherein the armature (32) acts on the closing element (29), which closes or opens a hydraulic connection from the high-pressure accumulator (12) to a valve chamber (26). The armature (32) comprises an armature plate (33) and an armature pin (34), wherein the armature pin (34) is axially guided in a valve housing (20). The armature pin (34) is implemented in two parts and has a transfer rod (51) and a pressure piece (52). The pressure piece (52) is disposed on the transfer rod (51) in a radially displaceable manner at an axial offset V.

### BACKGROUND OF THE INVENTION

The invention relates to a pressure regulating valve.

During the operation of an auto-ignition internal combustion engine with a high-pressure accumulator (common rail), the fuel system pressure in the high-pressure accumulator is kept substantially constant by means of a pressure regulating valve. If the pressure in the high-pressure accumulator exceeds the system pressure, the pressure regulating valve opens, and when the pressure has fallen below the system pressure again, the pressure regulating valve closes. It is ensured in this way that the injection of fuel into the cylinders of the internal combustion engine takes place under consistent conditions. If the fuel pressure in the high-pressure accumulator falls below the vapor pressure of the air dissolved in the fuel, the air is outgassed such that the high-pressure accumulator contains not only the liquid fuel but also a gas phase. Upon starting of the internal combustion engine, it is then necessary for the gas contained in the high-pressure accumulator to be compressed by the high-pressure pump in order that the pressure required for operation builds up in the high-pressure accumulator. Depending on the starting temperature of the internal combustion engine, several engine revolutions are required for this purpose, which results in starting delays. To permit a release of the air contained in the high-pressure accumulator, provision is made for the pressure regulating valve to be placed into the open state when the engine is shut down.

DE 10 2004 002 964 A1 discloses a pressure regulating valve in which, when the internal combustion engine is at a standstill, the pressure regulating valve is open, that is to say a connection from the high-pressure accumulator to a low-pressure line is opened up by a closing element. For this purpose, the pressure regulating valve has a magnet actuator which, for the closure of the closing element, is electrically energized such that an armature moves the closing element into a valve seat. For the opening of the closing element, a spring element is provided which acts counter to the magnet force of the magnet actuator and which thereby moves the armature, and an armature pin fastened thereto, in an opening direction, whereby the closing element is lifted from the valve seat and opens up a hydraulic return connection between the high-pressure accumulator and the low-pressure line. The hydraulic return connection to the low-pressure line proceeds from a valve chamber which is positioned downstream of the valve seat, with bores being provided which branch off laterally and radially from said valve chamber and issue into a low-pressure line in the housing of the high-pressure accumulator.

### SUMMARY OF THE INVENTION

The pressure regulating valve according to the invention has the advantage that, owing to the axial offset, the guidance for the closing element is improved with regard to a congruent valve seat. The otherwise conventional stamping process with the closing element for forming the congruent valve seat for the spherical closing element in the assembled component can thereby be eliminated. In this way, it is even possible for different materials to be used for the valve plate and for the closing element.

The implementation of the axial offset can be realized in a simple manner by virtue of the transmission rod having, on an end face at the valve seat side, a cylindrical receptacle for the thrust piece, in which receptacle the thrust piece is arranged with the axial offset and in a radially displaceable manner. The thrust piece expediently has a cylindrical portion and a conical portion, wherein the cylindrical portion is arranged in the receptacle of the transmission rod. It is furthermore expedient for the closing element of spherical form to be received in a spherical-cap-shaped receptacle on the conical portion.

A particularly advantageous exemplary embodiment is attained by virtue of the transmission rod being formed with a return connection which hydraulically connects the valve chamber to an armature chamber, in which armature chamber the armature plate of the armature is received and which armature chamber can be hydraulically connected to a low-pressure port. The return connection integrated in the transmission rod is expediently realized by virtue of the transmission rod being in the form of a tube, wherein the return connection is formed by the inner diameter of the tube, and a transverse bore leads from the interior of the tube through the tube wall into the valve chamber. In said embodiment, it is expedient for the return port to be formed on an insert which delimits the armature chamber in a hydraulically sealed manner, wherein on the insert there is formed a port piece which has a connecting line which forms a hydraulic connection of the armature chamber to the return port.

### BRIEF DESCRIPTION OF THE DRAWINGS

Exemplary embodiments of the invention are illustrated in the drawing and explained in more detail in the following description.

In the drawing:

FIG. 1 is a sectional illustration through a pressure regulating valve according to the invention as per a first exemplary embodiment,

FIG. 2 is an enlarged sectional illustration of a detail X in FIG. 1,

FIG. 3 is a sectional illustration through a pressure regulating valve according to the invention as per a second exemplary embodiment, and

FIG. 4 is an enlarged sectional illustration of a detail Y in FIG. 3.

### DETAILED DESCRIPTION

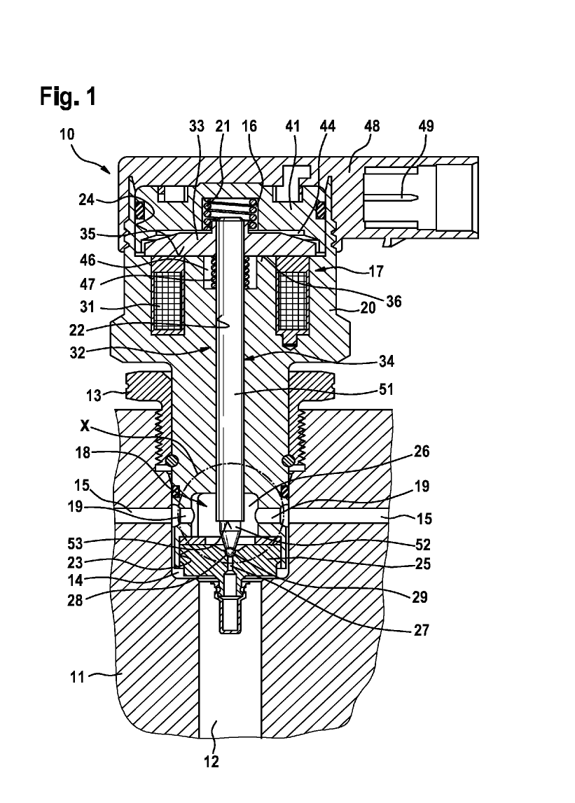

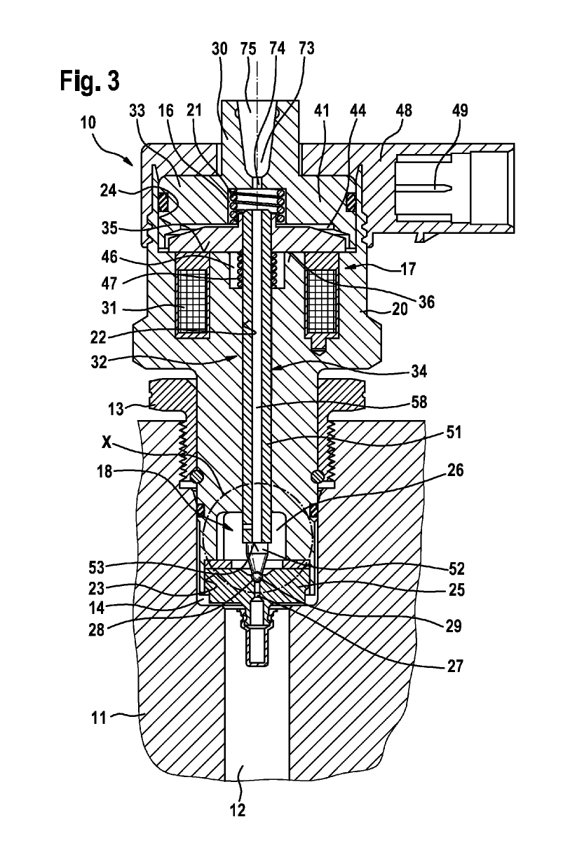

The pressure regulating valves 10 illustrated in FIGS. 1 and 3 are in each case inserted into a housing 11 of a high-pressure accumulator 12 of a fuel injection device by means of a threaded sleeve 13 inserted into a receiving chamber 14. Here, the pressure regulating valve 10 closes or opens a hydraulic connection from the high-pressure accumulator 12 to a low-pressure port 15 as in FIG. 1 or a low-pressure port 75 as in FIG. 3, said low-pressure ports being connected in each case to a low-pressure line which leads back to a fuel tank (likewise not illustrated).

The pressure regulating valve 10 has a magnet actuator 17 and a valve element 18, wherein the magnet actuator 17 actuates the valve element 18. The magnet actuator 17 and the valve element 18 are arranged in a valve housing 20 which has a guide 22, a receptacle 23 at the high-pressure chamber side and a receptacle 24 at the port side.

In the receptacle 23 at the high-pressure chamber side there is arranged the valve element 18 which comprises a valve piece 25 and a closing element 29 which is expediently of spherical form. The valve piece 25, for example via a spacer ring, delimits a valve chamber 26. Through the valve piece 25 there leads a throttle bore 27 which hydraulically connects the valve chamber 26 to the high-pressure accumulator 12. In the valve piece 25 there is also formed a valve seat 28 for the closing element 29. The valve chamber 26 is positioned downstream of the valve seat 28, such that the closing element 29 is arranged within the valve chamber 26.

The magnet actuator 17 comprises a magnet coil 31 and an armature 32, wherein the magnet coil 31 acts on the armature 32. The armature 32 is formed with an armature plate 33 and an armature pin 34, wherein the armature pin 34 is fixedly connected to the armature plate 33. The armature pin 34 is guided axially in the guide 22, wherein the guide 22 extends axially through the valve housing 20. The magnet coil 31, together with the surrounding housing part of the valve housing 20, forms a magnet core with a magnet core end surface 35.

An insert 41 is inserted, and hydraulically sealed by means of a sealing ring, in the receptacle 24 at the port side. The insert 41 and the magnet core end surface 35 delimit an armature chamber 44 in which the armature plate 33 is arranged in an axially movable manner. Into the magnet core end surface 35 there is formed a first spring chamber 46 for a compression spring 47 which acts on the magnet armature 32 in the opening direction of the closing element 29. In the insert 41 there is formed a further spring chamber 16 for a further compression spring 21, which acts on the magnet armature 32 in the closing direction of the closing element 29. The insert 41 is held on the valve housing 20 by means of an injection-molded encapsulation 48 which comprises electrical plug contacts 49 for the magnet coil 31.

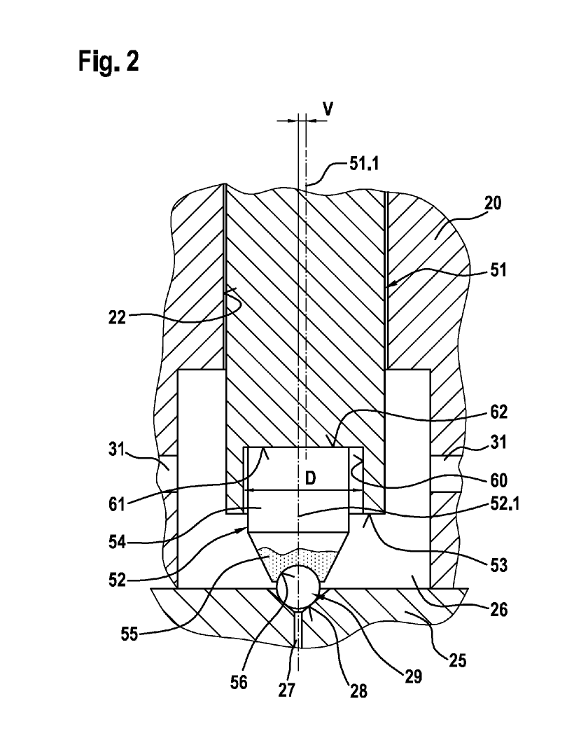

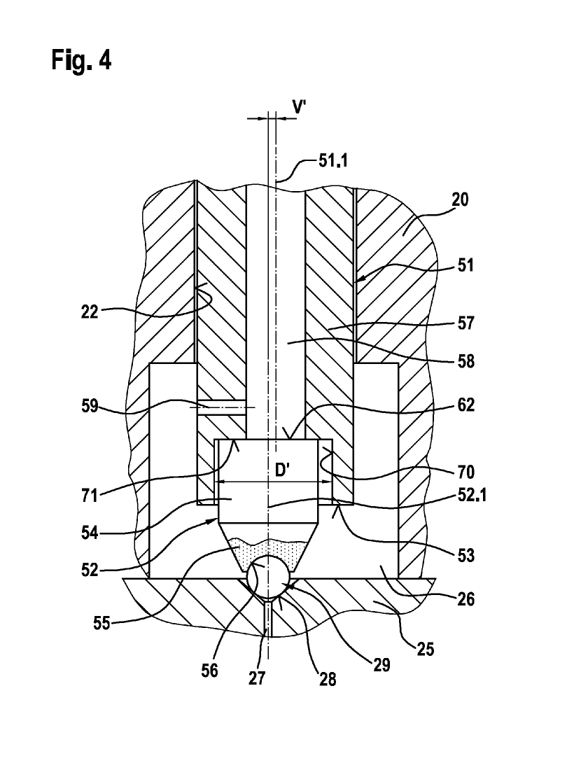

In both exemplary embodiments, the armature pin 34 is of two-part form and has a transmission rod 51 with an axis 51.1 and a thrust piece 52 with an axis 52.1 (FIGS. 2, 4). The transmission rod 51 is fixedly connected to the armature plate 33. The thrust piece 52 is arranged on an end face 53 of the transmission rod 51 at the valve-seat side and acts on the spherical closing element 29. As shown in the details illustrated in FIGS. 2 and 4, the thrust piece 52 has a cylindrical portion 54 with an end surface 62 and a conical portion 55 with a spherical-cap-shaped receptacle 56, wherein the spherical-cap-shaped receptacle 56 serves for receiving the spherical closing element 29.

In the exemplary embodiment in FIGS. 1 and 2, it is for example provided that two outlet bores 19 lead from the valve chamber 26 through the valve housing 20 to two return ports 15, such that said valve chamber 26 is hydraulically coupled to the low-pressure line via the return ports 15. In the exemplary embodiments in FIGS. 1 and 2, the transmission rod 51 is formed from solid material and, on the end face 53 at the valve-seat side, has a substantially cylindrical receptacle 60 with a diameter D and an inner end surface 61 against which the end surface 62 of the thrust piece 52 bears. The thrust piece 52 is received with the cylindrical portion 54 in the receptacle 60, wherein the cylindrical portion is arranged in the receptacle 60 with play, such that there is a radial offset V between the axes 52.2 of the cylindrical portion 54 of the thrust piece 52 and the axis 51.1 of the transmission rod 51.

In the exemplary embodiment of FIGS. 3 and 4, a return connection which hydraulically connects the valve chamber 26 to the armature chamber 44 is integrated into the transmission rod 51. Here, the return connection is formed by a passage opening 58, which issues into the armature chamber 44, and by a transverse bore 59 which branches off laterally and issues into the valve chamber 26. The return connection between the valve chamber 26 and armature chamber 44 serves primarily for dynamic pressure equalization between the two pressure chambers.

It is thus expediently possible for the transmission rod 51 to be in the form of a tube 57, wherein the inner diameter of the tube 57 forms the passage opening 58 and the transverse bore 59 extends through the tube wall. On the end face 53 at the valve-seat side, the tube 57 has a substantially cylindrical receptacle 70 with a diameter D′ and an inner end surface 71 against which the end surface 62 of the thrust piece 52 bears. The thrust piece 52 is received with the cylindrical portion 54 in the receptacle 70, wherein the cylindrical portion 54 is arranged in the receptacle 70 with play, such that there is a radial offset V′ between the axes 52.1 of the cylindrical portion 54 of the thrust piece 52 and the axis 52.1 of the tube 57.

Furthermore, in the exemplary embodiment in FIGS. 3 and 4, the insert 41 has a port piece 30 in which there is formed a connecting line 73 with, for example, a throttle 74, wherein the connecting line 73 forms a hydraulic connection of the armature chamber 44 to the return port 75. In this way, the valve chamber 26 is connected via the transverse bore 59, the passage opening 58, the armature chamber 44 and the connecting line 73 to the return portion 75, which in turn is hydraulically connected to the low-pressure line (not illustrated). In the exemplary embodiment in FIG. 3, the return port 75 may also be connected directly to the valve chamber 26, as in the exemplary embodiment of FIG. 1.

1. A pressure regulating valve for opening and closing an outlet of a high-pressure accumulator (12) for an injection device for an internal combustion engine, comprising a valve element (18) which is arranged in a valve housing (20) and which can be actuated by a magnet actuator (17), said magnet actuator acting with an armature (32) on a closing element (29) of the valve element (18), which closing element closes or opens up a hydraulic connection from the high-pressure accumulator (12) to a valve chamber (26) formed in the valve housing (20), wherein the valve chamber (26) is hydraulically connected to a return port (15, 75), and wherein the armature (32) has an armature plate (33) and an armature pin (34) which is guided axially in the valve housing (20), characterized in that the armature pin (34) is formed at least in two parts with a transition rod (51) and a thrust piece (52), and the thrust piece (52) is arranged with an axial offset V, V′ and in a radially displaceable manner on the transmission rod (51).

2. The pressure regulating valve according to claim 1, characterized in that the transmission rod (51) has, on an end face (53) at a valve seat side, a substantially cylindrical receptacle (60, 70) for the thrust piece (52).

3. The pressure regulating valve according to claim 2, characterized in that the receptacle (60, 70) has an inner end surface (61) against which an end surface (62) of the thrust piece (52) bears.

4. The pressure regulating valve according to claim 2, characterized in that the thrust piece (52) has a cylindrical portion (54) and a conical portion (55), and in that the thrust piece (52) is arranged with the cylindrical portion (54) in the receptacle (60, 70).

5. The pressure regulating valve according to claim 4, characterized in that the conical portion (55) has a spherical-cap-shaped receptacle (56) for a spherical closing element (29).

6. The pressure regulating valve according to claim 1, characterized in that the transmission rod (51) is formed with a return connection (58, 59) which hydraulically connects the valve chamber (26) to the armature chamber (44).

7. The pressure regulating valve according to claim 6, characterized in that the armature plate (33) of the armature (32) is received in the armature chamber (44).

8. The pressure regulating valve according to claim 6, characterized in that the transmission rod (51) is in the form of a tube (57) and in that the return connection (58, 59) is formed by an inner diameter of the tube (57) and by a transverse bore extending through a tube wall.

9. The pressure regulating valve according to claim 6, characterized in that the armature chamber (44) is hydraulically connected to the return port (75).

10. The pressure regulating valve according to claim 9, characterized in that the return port (75) is formed in an insert (41) which delimits the armature chamber (44) in a hydraulically sealed manner, and in that on the insert (41) there is formed a port piece (30) with a connecting line (73) which forms a hydraulic connection of the armature chamber (44) to the return port (75).
